(19) United States
(12) Patent Application Publication
(10) Pub. No.: US 2007/0097128 A1
(43) Pub. Date: May 3, 2007

(54) Apparatus and method for forming scene-based vector animation

(75) Inventor: Ji-taek Lim, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/591,522

(22) Filed: Nov. 2, 2006

(30) Foreign Application Priority Data
Nov. 2, 2005 (KR) 10-2005-0104227

(51) Int. Cl. G06T 15/70

(52) U.S. Cl. 345/473

(57) ABSTRACT

An apparatus for forming scene-based vector animation includes: an animation component database which stores vector information for basic animation components, a scene listing database which stores scene information for each scene which includes the animation components, an alarm generation unit which generates an alarm at predetermined intervals, an animation manager which obtains scene information from the scene listing database and extracts vector information for corresponding animation components from the animation component database according to the scene information, and which forms a scene, and transmits the scene to an external device when the alarm is generated. An input/output device provides an interface between an external keyboard or a display device or the like and the apparatus for forming an animation.

### CROSS-REFERENCE TO RELATED PATENT APPLICATION

This application claims the benefit of Korean Patent Application No. 10-2005-0104227, filed on Nov. 2, 2005, in the Korean Intellectual Property Office, the disclosure of which is incorporated herein in its entirety by reference.

### BACKGROUND OF THE INVENTION

1. Field of the Invention

Apparatuses and methods consistent with the present invention relate to forming scene-based vector animation, and more particularly, to an apparatus for forming scene-based vector animation capable of generating and providing optimized scenes for embedded systems having limited resources by composing an animation scene using vector information of components.

2. Description of the Related Art

Typical user interfaces have the limitation of having only still graphic components which may not provide users sufficient information and functions simultaneously in an animation generation. In addition, such user interfaces may not provide enough entertainment or be sufficiently interactive for users. However, it is not easy to introduce dynamic graphic components to user interfaces for animation generation. Generating an animation using an authoring tool is a commonly used method. However this method requires a high specification system to drive the generated animation.

FIG. 1 is a constructional view of an animation generation system disclosed in Korean Patent Application Publication No. 2003-0049748.

Referring to FIG. 1, a graphic component, downloadable via the Internet, is stored in a database server 100. A user interface 111 is used to receive text data from a user and the text data is analyzed by an analysis module 112. A locus index database 113 stores a graphic component index and a locus equation corresponding to the analysis result of the analysis module 112. A graphic component database 115 stores a graphic component. An animation generation module 116 forms an animation using the locus equation and the graphic component.

Now, a method of forming an animation will be described with reference to FIG. 1. When a user inputs text data through the user interface 111, the analysis module 112 of the system receives the text data. Then the analysis module 112 analyzes the input text data and searches a locus equation and a graphic index corresponding to the text data in the locus index database 113 and the graphic component database 115, respectively. The system extracts graphic components using the searched indexes from the graphic component database 115.

The animation generation module 116 generates a thematic graphic by combining the extracted components and forms an animation according to time by applying the locus equation.

However, the conventional technology has the following problems.

First, according to the conventional technology, the animation can be formed using determined shapes of the graphic component and the locus equation. However, an animation of a form required by a user cannot be generated. In other words, the user is permitted to input text data only for executing several predetermined animation.

Second, since a technology for an animation editing process is not described specifically, there is no possibility of a change of motion in the animation or transformation of a graphic component.

### SUMMARY OF THE INVENTION

The present invention provides an apparatus for forming a scene-based vector animation capable of generating and providing scenes optimized for an embedded system having limited resources by generating a scene using vector information for components.

The present invention also provides an apparatus for forming an animation capable of utilizing free transformation functions of vector graphics and generating a variety of animation required by a user by optimizing a scene format.

According to an aspect of the invention, there is provided an apparatus for forming an animation comprising: an animation component database which stores vector information related to basic animation components; a scene listing database which stores scene information related to a plurality of scenes comprising the animation components; an alarm generation unit which generates an alarm at predetermined intervals; an animation manager which obtains the scene information form the scene listing database and extracts the vector information from the animation component database according to the scene information obtained the scene listing database, and which forms a scene based on the scene information and the vector information, and transmits the scene to an external device when the alarm is generated; and an input/output device interface which enables an interface between the external device and the apparatus for forming an animation.

In the above aspect, the animation components may comprise at least one of a shape animation component, an image animation component, a text animation component, and a group animation component.

In addition, the scene information may comprise action information and a plurality of scene components. The action information may comprise an action command and a scene number. Each of the scene components may comprise at least one of vector information, a depth value, a line style, a paint style and a matrix for the animation component.

In addition, the animation manager may form a plurality of scenes using the animation components stored in the animation component database and store scene information for each scene in the scene list database.

In addition, the apparatus for forming an animation may further comprise an animation component generation module which generates vector information for basic animation components comprising a line and a text.

### BRIEF DESCRIPTION OF THE DRAWINGS

The above and other aspects of the present invention will become more apparent by the following detailed description of exemplary embodiments thereof with reference to the attached drawings in which:

FIG. 1 is a constructional view of an animation generation system disclosed in Korean Patent Application Publication No. 2003-0049748;

FIG. 2 is a block diagram illustrating a structure of an apparatus for forming a scene-based vector animation according to an exemplary embodiment of the present invention and external devices;

FIG. 3 is a diagram illustrating types of animation components according to an exemplary embodiment of the present invention;

FIG. 4 is a diagram illustrating scene information constituting a scene according to an exemplary embodiment of the present invention;

FIG. 5 is a diagram illustrating exemplary shape components of animation according to an exemplary embodiment of the present invention;

FIG. 6 is a flowchart illustrating generation of animation components and a scene according to an exemplary embodiment of the present invention; and

FIG. 7 is a flowchart illustrating formation of a scene based vector animation according to an exemplary embodiment of the present invention.

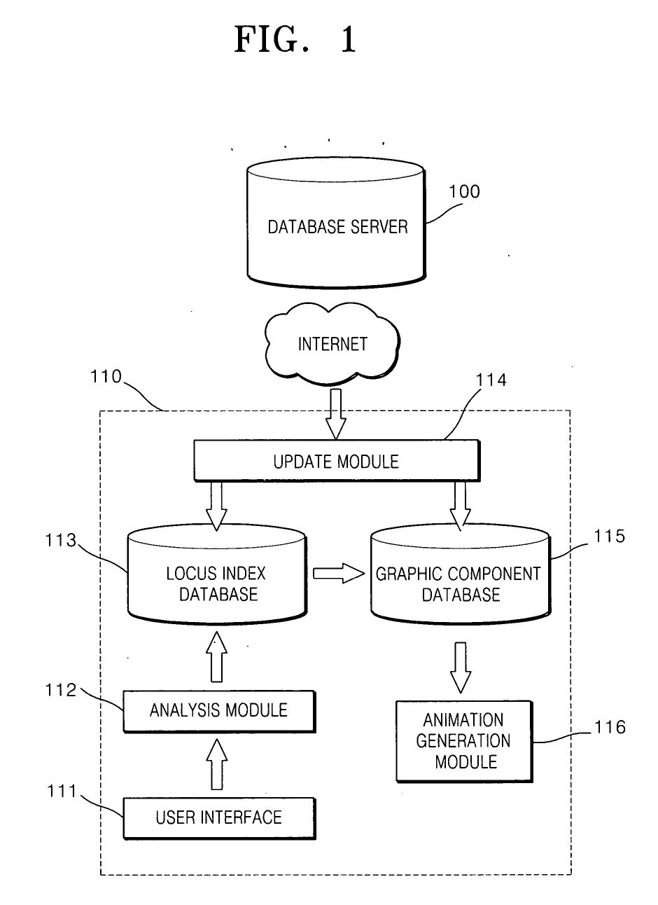

### DETAILED DESCRIPTION OF EXEMPLARY EMBODIMENTS OF THE INVENTION

Hereinafter, the present invention will be described in detail by describing exemplary embodiments of the invention with reference to the attached drawings. Like reference numerals denote like elements in the drawings. In the description below, specific objects such as a specific element in a circuit are illustrated only for overall understanding of the present invention, and it is self evident to those skilled in the art that the present invention can be used without the specific objects. In describing the present invention, detailed descriptions of related known functions or configurations are omitted when the description may deviate from the essence of the present invention.

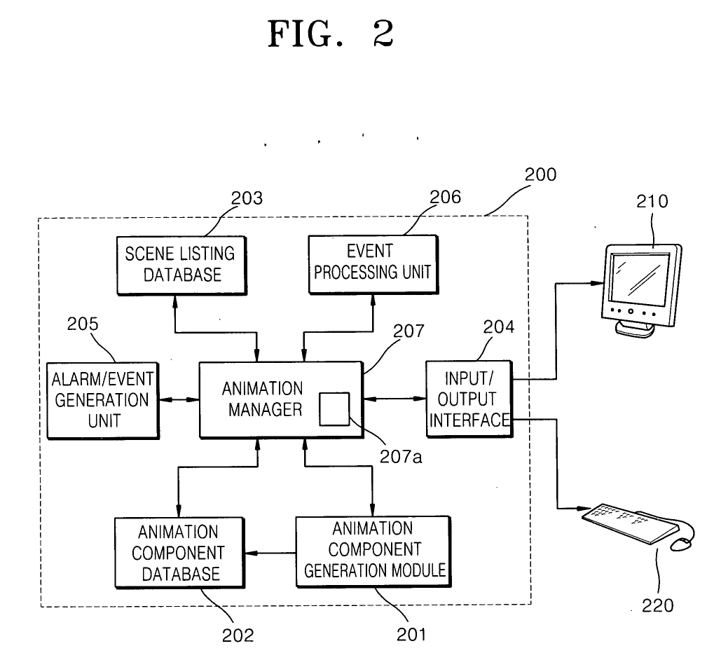

FIG. 2 is a block diagram illustrating a structure of an apparatus 200 for forming a scene-based vector animation according to an exemplary embodiment of the present invention and a display device 210 and a keyboard/mouse 220. The apparatus 200 includes an animation component generation module 201, an animation component database 202, a scene listing database 203, an input/output interface 204, an alarm/event generation unit 205, an event processing unit 206, an animation manager 207, and a memory 207a. The apparatus 200 for forming a scene-based vector animation interfaces with a user through the display device 210 and the keyboard/mouse 220.

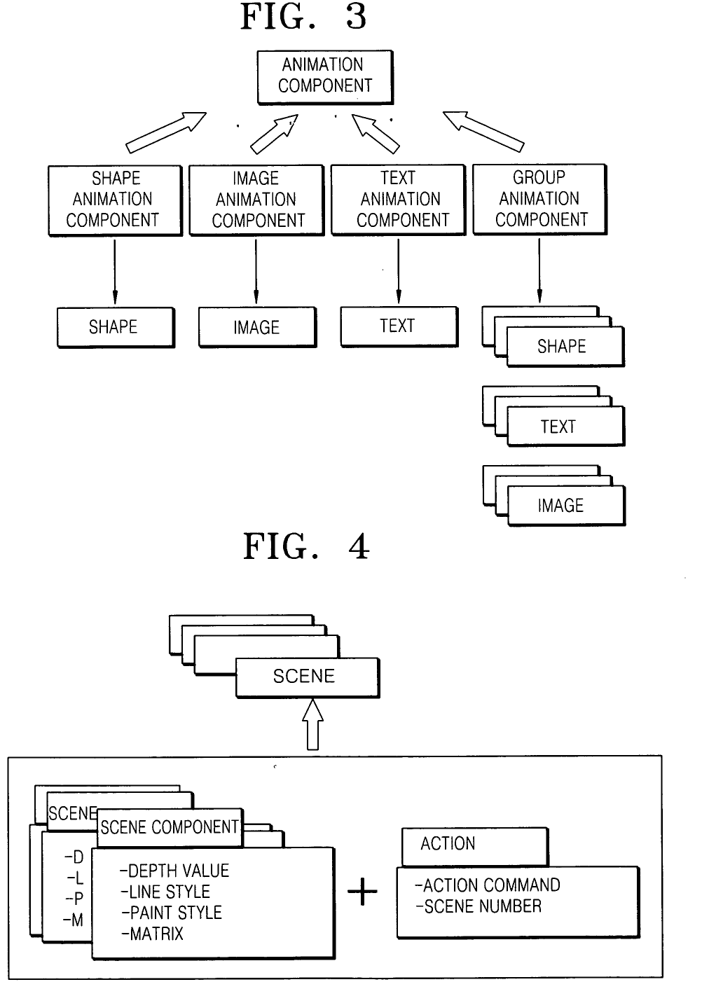

The animation component generation module 201 generates an animation component, and the animation component is illustrated in FIG. 3 according to an exemplary embodiment of the present invention. More specifically, the animation component includes at least one of a shape animation component, an image animation component, a text animation component, and a group animation component.

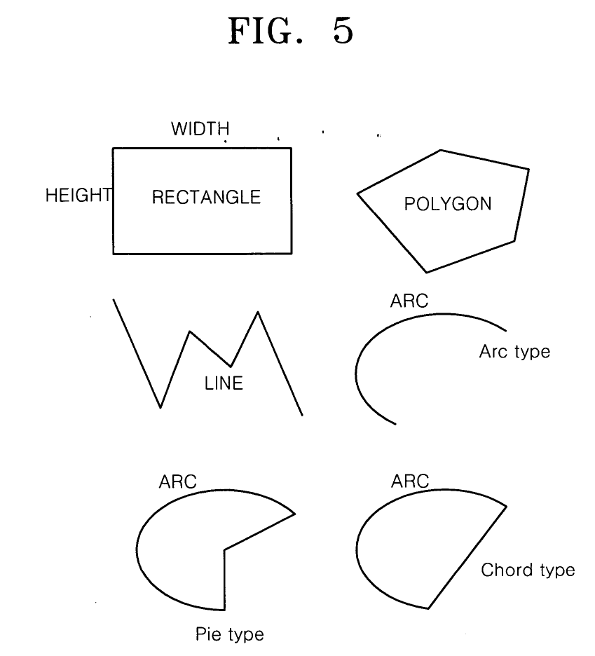

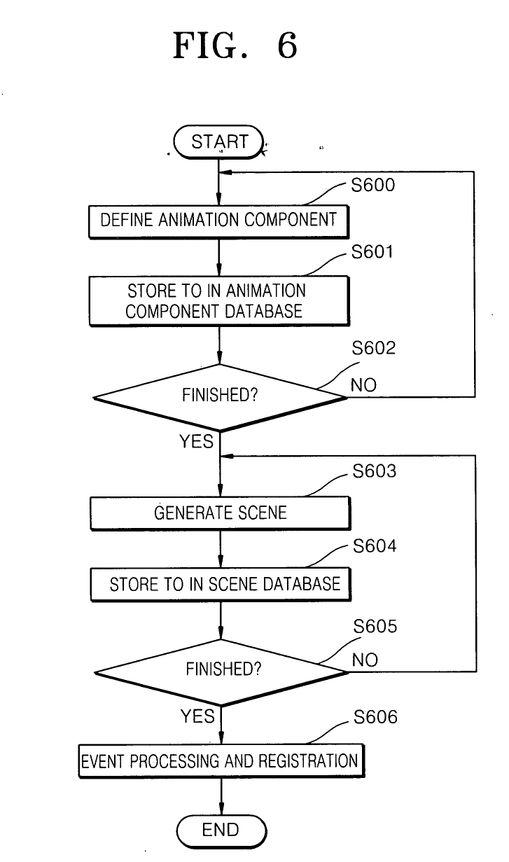

The shape animation component defines a shape. Examples of the shapes are illustrated in FIG. 5. These include a rectangle, a polygon, a line, and an arc. Examples of the arc type include a pie type, a chord type, and the like.

The image animation component indicates an image type, and a text animation component indicates text. The text may be displayed using fonts stored in advance, or the text may be transformed into a shape and defined as a transformed shape. The group animation component includes a group of the shape animation components, the image animation components, or the text animation components. The components will move together as the same group.

The animation component database 202 stores vector information for basic animation components generated by the animation generation module 201.

The scene listing database 203 stores scene information for each scene. The scene includes the animation components. The scene information includes action information and a plurality of scene components. The information for the action includes an action command and a scene number. Each of the scene components includes at least one of vector information, a depth value, a line style, a paint style and a matrix for an animation component.

FIG. 4 is a diagram illustrating scene information included in a scene, in other words, action information and a plurality of scene components according to an embodiment of the present invention.

Referring to FIG. 4, the action information represents progress information, and, for example, the action information may include action commands such as Play, Stop, Pause, Goto, Backward, and Forward. For the Goto command, a scene number for a destination scene is included in the action information.

The vector information is, for example, vector information for a shape illustrated in FIG. 5. The depth value is a comparative value indicating which animation component is to be laid over another when there is a superposition of animation components. In a shape animation component, information for a line style or a paint style is defined, and matrix represents location information in a corresponding scene for an animation component.

The input/output interface 204 is responsible for an interface between the keyboard/mouse 220, or the display device 210 and the apparatus 200 for forming a scene-based vector animation. The user can generate animation components required or display a generated scene through the display device 210 and the keyboard/mouse 220.

The alarm/event generation unit 205 sets an alarm or an event at predetermined intervals. The alarm/event generation unit 205 transmits the alarm or the event to the animation manager 207 when the alarm or the event is generated or occurs according to the predetermined period.

The event processing unit 206 calls an event handler stored in the event processing unit 206 according to an event type, when the event occurs in the alarm/event generation unit 205. In other words, when a specific key is pressed, the event processing unit 206 calls the event handler corresponding to the key, for example, when an Enter key is pressed, the event processing unit 206 calls a “Pressed” event handler, and when a focus is input to a scene window, the event processing unit 206 calls a “Focus_In” event handler.

The animation manager 207 controls the components 201 to 206 of the apparatus 200. In other words, when an alarm is generated, the animation manager 207 refers to the scene listing database 203 for scene information, extracts vector information for corresponding animation components from the animation component database 202 according to the scene information, generates a corresponding scene, and transmits the formed scene to an external device, for example, the display device 210, to be displayed.

The animation manager 207 forms a plurality of scenes using animation components stored in the animation component database 202, by interaction with a user through the display device 210 and the keyboard/mouse 220, and stores scene information for each of the formed scenes in the scene listing database 203.

The screen buffer memory 207a temporarily stores a scene to be transmitted to an external device, more specifically, to the display device 210 and functions as a buffer for the external device, more specifically, the display device 210.

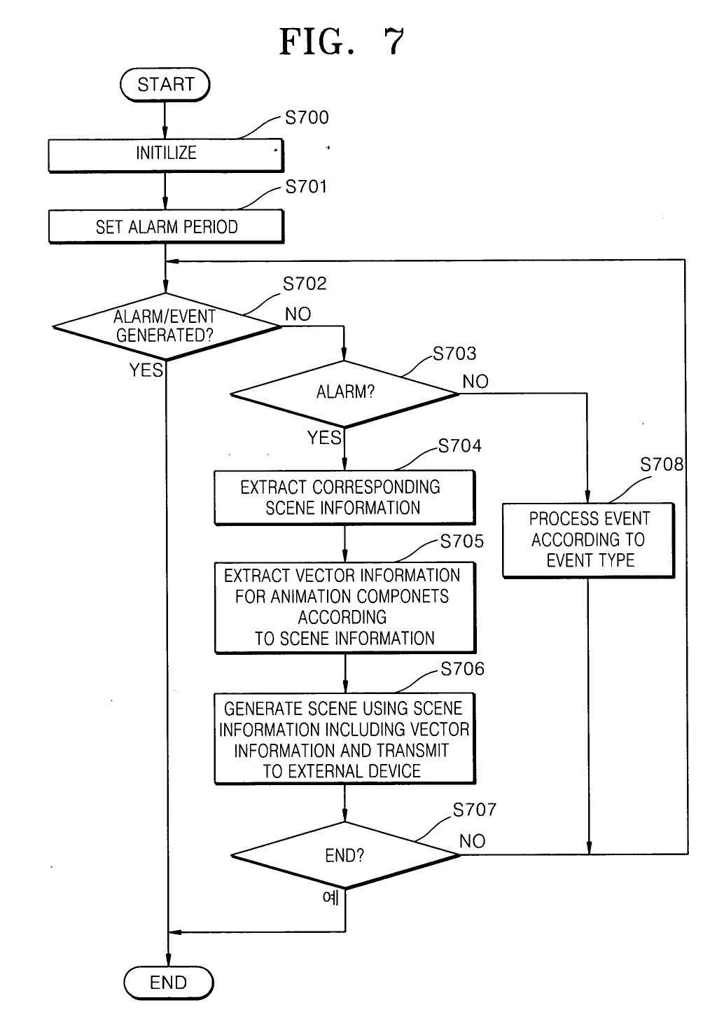

FIG. 6 is a flow chart illustrating a method of generating animation components and a scene according to an exemplary embodiment of the present invention. The method includes animation component defining and storing operations S600 and S601, scene generating and storing operations S603 and S604, and an event processing and registration operation S606. The above operations are classified only for the convenience of description, and some of these operations can be performed as a separate stage.

Referring to FIG. 6, a user defines animation components required to generate a scene through the display device 210 and the keyboard/mouse 220 in the animation component defining and storing operations S600 and S601. In other words, a user defines visual coordinates for each animation component, and inputs vector information required to define a shape for a shape animation component.

For example, a height and width of a rectangle and width wrapping an arc, height, start angle, and finish angle for an arc are input as vector information. Also, vector information for several points of a polygon or a line is required. The defined animation components are stored in the animation component database 202 in operation S601. Operations S600 and S601 are repeated every time a new animation component is required.

Vector information for animation components required is extracted from the animation component database 202, and a corresponding scene is generated in the scene generation and storing operations S603 and S604. In addition, action information which indicates the next action after displaying a corresponding scene is defined. The generated scene is stored in the scene listing database 203.

A user defines and stores an event handler for a specific key or a specific event, for example, Focus In/Out or Pressed, through the animation manager 207 in the event processing and registration operation S606.

FIG. 7 is a flow chart illustrating a method of forming a scene-based vector animation according to an exemplary embodiment of the present invention.

Referring to FIG. 7, when the apparatus 200 is turned on, the animation manager 207 performs standard initializing procedures in operation S700. The animation manager 207 receives an initial scene, initializes an index of an animation scene, and assigns a screen buffer memory 207a for a corresponding scene.

In operation S701, the animation manager 207 sets an alarm in the alarm/event generation unit 205 for periodically processing an animation scene. Then the apparatus 200 waits until an alarm is generated (operation S702).

When an alarm or an event is generated or occurs in operation S702, it should be determined whether an alarm or an event occurs, and when an alarm is detected (operation S703), scene information corresponding to a scene is extracted in operation S704. As described above, the scene information includes action information and a plurality of scene components as illustrated in FIG. 4, and the action information includes an action command and a scene number. Each of the scene components includes at least one of vector information, a depth value, a line style, a paint style and a matrix.

The animation manager 207 extracts vector information for animation components from the scene information in operation S705. In operation S706, the action manager 207 extracts a corresponding animation component from the animation component database 202, generates a scene, and stores the scene in the screen buffer memory 207a.

Describing operations S705 and S706 in detail, when an alarm is generated, the animation manager 207 extracts vector information for an animation component from the animation component database 202 according to scene information and applies a line or paint style according to scene information. The animation manager 207 designates a location for a corresponding animation component using matrix information.

In this case, proper procedures are performed according to a type of the animation component. In other words, a style of a shape is defined and rendered through a matrix for a shape animation component. On the other hand, a text animation component may be processed using a predefined font or the text may be stored in a form of a path, so that the path may be rendered. The image animation component may be interpreted by an adequate decoder for drawing.

When all the animation components are processed through the operations described above, a scene is generated, and the scene is stored in the screen buffer memory 207a, and the stored scene is transmitted to an external device 210 for a display.

In operation 707, after determining whether the alarm is final or not, the apparatus 200 waits for another alarm when the alarm is determined not to be final. In this case, when another alarm is generated, the apparatus 200 extracts the next scene according to the action information in the previous scene from the scene listing database 203. In other words, when action information in the previous scene is Stop, the animation is stopped, and when the action information is Goto, the animation skips to a scene corresponding to a scene number, and operations S704 to S706 are performed for a corresponding scene.

When an event occurs in the alarm/event generation unit 205, a corresponding event handler stored in the event processing unit 206 is called for processing in operation S708. In other words, when a specific key is pressed, an event handler of a corresponding key is called. When Enter key is pressed, “Pressed” event handler is called, and when a focus is input, then Focus_In event handler is called for processing.

While the present invention has been particularly shown and described with reference to exemplary embodiments thereof, it will be understood by those skilled in the art that various changes in form and details may be made therein without departing from the spirit and scope of the present invention as defined by the appended claims.

What is claimed is:

1. an apparatus for forming an animation comprising:
an animation component generation module which defines animation components and generates vector information related to the animation components;
an animation component database which stores vector information of the animation components; and
an animation manager which forms a scene using the vector information of the animation components.

2. The apparatus of claim 1, further comprising a scene listing database which stores scene information related to a plurality of scenes comprising the animation components.

3. The apparatus of claim 2, wherein the animation manager forms a plurality of scenes according to the scene information if an alert or even occurs.

4. The apparatus of claim 2, wherein the scene information comprises action information and a plurality of scene components, wherein the action information comprises an action command and a scene number, and wherein each of the scene components comprises at least one of vector information, a depth value, a line style, a paint style, and a matrix for the animation component.

5. The apparatus of claim 1, wherein the animation components comprise a shape animation component, an image animation component, a text animation component, and a group animation component.

6. the apparatus of claim 1, further comprising an interface which enables an interface between an external device and the apparatus for forming an animation.

7. A method of forming a scene-based vector animation, the method comprising:
defining animation components;
generating vector information of the animation components; and
forming a scene using the vector information of the animation components.

8. The method of claim 7, further comprising forming a plurality of scenes according to scene information if an alert or event occurs.

9. The method of claim 7, wherein the animation components comprise a shape animation component, an image animation component, a text animation component, and a group animation component.

10. The method of claim 8, wherein the scene information comprises action information and a plurality of scene components, wherein the action information comprises an action command and a scene number, and wherein each of the scene components comprises at least one of vector information, a depth value, a line style, a paint style, and a matrix for the animation component.

11. A computer-readable medium having embodied thereon a computer program enabling a computer to perform a method of forming a scene-based vector animation, the method comprising:
defining animation components;
generating vector information of the animation components; and
forming a scene using the vector information of the animation components.
